(19) United States
(12) Patent Application Publication
(10) Pub. No.: US 2018/0253984 A1
(43) Pub. Date: Sep. 6, 2018

(54) Terrain avoidance device and method for an aircraft

(71) Applicant: Airbus Operations SAS, TOULOUSE (FR)

(72) Inventors: Olivier LAPLACE, COLOMIERS (FR); Camille CARUHEL, TOULOUSE (FR); Thierry BOURRET, TOULOUSE (FR); Sophie LAMBEAUX, TOURNEFEUILLE (FR)

(21) Appl. No.: 15/899,798

(22) Filed: Feb. 20, 2018

(30) Foreign Application Priority Data
Mar. 2, 2017 (FR) 1751716

(51) Int. Cl. G08G 5/04; G08G 5/00; B64D 45/00; G01S 13/94

(52) U.S. Cl. CPC G08G 5/045; G01S 13/94; B64D 45/00; G08G 5/0086

(57) ABSTRACT

In an aircraft comprising a terrain warning device monitoring the flight of the aircraft with respect to the surrounding terrain and a terrain sensor, the terrain avoidance device is linked to the terrain warning device, to the terrain sensor and to a terrain relief database. The terrain avoidance device comprises a processing unit configured to determine a valid terrain avoidance trajectory as a function at one and the same time of an item of information regarding current position of the aircraft, of terrain relief information arising from the database and of terrain relief information provided by the terrain sensor when the terrain avoidance device receives a warning signal from the terrain warning device.

### CROSS-REFERENCES TO RELATED APPLICATIONS

This application claims the benefit of the French patent application No. 1751716 filed on Mar. 2, 2017, the entire disclosures of which are incorporated herein by way of reference.

### BACKGROUND OF THE INVENTION

The invention relates to the avoidance of a relief of the terrain overflown by an aircraft.

Aircraft, transport airplanes in particular, comprise a terrain warning system, generally called TAWS (“Terrain Avoidance Warning System”) for example of EGPWS (“Enhanced Ground Proximity Warning System”) type or of GCAS (“Ground Collision Avoidance System”) type. Such a warning system emits a warning signal if the current trajectory of the aircraft is such that the aircraft risks a collision with the terrain if it does not modify this trajectory. Document U.S. Pat. No. 7,899,620B2 describes a terrain avoidance system for an aircraft, determining and applying a terrain avoidance trajectory when it receives a warning signal originating from the terrain proximity warning system. This avoidance trajectory corresponds to a climb of the aircraft according to an optimal slope, if necessary combined with a change of heading with respect to the heading of the current trajectory of the aircraft. The optimal slope is a maximum slope flyable by the aircraft while taking account of its configuration and while adapting, if necessary, the thrust of the engines. The avoidance trajectory is determined as a function of an item of information regarding current position of the aircraft and of terrain relief information contained in a terrain relief database on board the aircraft. This terrain relief database is, for example, integrated into the TAWS terrain warning system. The principle of such a terrain avoidance system is beneficial since it makes it possible to improve the safety of the aircraft. However, having regard to the risks of collision with the relief, the avoidance trajectory must be determined with an integrity level in accordance with the requirements of the air regulations in force. The latter correspond to a failure probability of less than 1×10−9 per flight hour. However, the integrity of airborne terrain databases does not make it possible to comply with such an integrity level. Moreover, the determination of the avoidance trajectory requires the knowledge of an item of information regarding current position of the aircraft, corresponding to the starting point of the avoidance trajectory. However, the integrity of the item of information regarding current position of the aircraft available on board the aircraft (provided for example by a system of GPS type) does not make it possible to comply with the aforementioned integrity level. It follows from this that the aforementioned piloting system cannot be implemented.

### SUMMARY OF THE INVENTION

An aim of the present invention is, in particular, to afford a solution to these problems. It relates to a terrain avoidance device for an aircraft, the terrain avoidance device comprising a processing unit and being intended to be linked:
to a terrain warning device of the aircraft, which monitors the flight of the aircraft with respect to the surrounding terrain and which is liable to emit a warning signal when the aircraft risks a collision with a relief of the terrain if it maintains its current flight characteristics;
to a position source of the aircraft, liable to provide an item of information regarding current position of the aircraft; and
to a terrain relief database.

The terrain avoidance device is noteworthy in that it is furthermore intended to be linked to a terrain sensor of the aircraft, liable to provide terrain relief information, and in that the processing unit of the terrain avoidance device is configured to:
determine a valid terrain avoidance trajectory as a function at one and the same time of an item of information regarding current position of the aircraft provided by the position source, of terrain relief information arising from the database and of terrain relief information provided by the terrain sensor, when the terrain avoidance device receives a warning signal from the terrain warning device; and
provide the valid terrain avoidance trajectory to a guidance system of the aircraft.

By using at one and the same time the item of information regarding current position of the aircraft provided by the position source, the terrain relief information arising from the database and the terrain relief information provided by the terrain sensor, it is made possible to circumvent a possible problem of integrity of the database and/or a possible problem of integrity of the item of information regarding current position of the aircraft: a possible error relating to the data of the database is thus detected by virtue of the terrain relief information provided by the terrain sensor. Consequently, the terrain avoidance trajectory is considered to be valid since it is determined on the basis of terrain relief information exhibiting a sufficient reliability level. Likewise, a possible error relating to the item of information regarding current position of the aircraft, liable to affect the starting point of the avoidance trajectory, is detected by virtue of the terrain relief information provided by the terrain sensor if this possible error is liable to give rise to a risk of collision of the aircraft with a relief of the terrain.

According to a first embodiment, the processing unit is configured to:
determine at least one potential terrain avoidance trajectory as a function of the item of information regarding current position of the aircraft provided by the position source and of terrain relief information arising from the database;
acquire, from the terrain sensor, measured-terrain relief information relating at least to a geographical zone corresponding to the potential terrain avoidance trajectory;
verify whether the potential terrain avoidance trajectory is at every point above the relief of the measured terrain; and
determine that the potential terrain avoidance trajectory is valid if the potential terrain avoidance trajectory is at every point above the relief of the measured terrain.

According to a first alternative, the processing unit is configured to instruct the acquisition, by the terrain sensor, of the measured-terrain relief information, after the determination of the potential avoidance trajectory, the measured-terrain relief information being related to a geographical zone corresponding to this potential avoidance trajectory.

According to a second alternative, the processing unit is configured to instruct the acquisition, by the terrain sensor, of the measured-terrain relief information, subsequent to the reception of the warning signal and before the determination of a potential avoidance trajectory, the measured-terrain relief information corresponding to a terrain avoidance geographical zone. In an advantageous manner, the processing unit is configured to instruct the acquisition, by the terrain sensor, of the measured-terrain relief information corresponding to an optimal climb slope of the aircraft.

According to a second embodiment, the processing unit is configured to:
acquire from the terrain sensor measured-terrain relief information relating to a so-called terrain avoidance geographical zone;
acquire from the database terrain relief information relating to the terrain avoidance geographical zone;
acquire from the position source an item of information regarding current position of the aircraft;
determine consolidated terrain relief information relating to the terrain avoidance geographical zone as a function of the measured-terrain relief information and terrain relief information arising from the database;
determine the valid terrain avoidance trajectory as a function of the item of information regarding current position of the aircraft and of the consolidated terrain relief information.

In an advantageous manner, the terrain avoidance geographical zone is subdivided into a set of elementary geographical zones and the consolidated terrain relief information corresponds, in each elementary geographical zone, to the higher item of information regarding terrain relief out of the item of information regarding terrain relief arising from the database and the item of information regarding relief of the measured terrain corresponding to this elementary zone.

In a particular embodiment, the terrain sensor is a radar installed on board the aircraft. In an advantageous manner, the radar is a radar liable to be instructed to acquire meteorological information or terrain relief information.

The invention also relates to a terrain avoidance method for an aircraft, the aircraft comprising:
a terrain warning device which monitors the flight of the aircraft with respect to the surrounding terrain and which is liable to emit a warning signal when the aircraft risks a collision with a relief of the terrain if it maintains its current flight characteristics;
a position source, liable to provide an item of information regarding current position of the aircraft;
a terrain sensor liable to provide terrain relief information; and
a terrain avoidance device linked to the terrain warning device, to the position source, to a terrain relief database as well as to the terrain sensor, this terrain avoidance device comprising a processing unit.

This method is noteworthy in that it comprises:
a step of determining, by the processing unit, a valid terrain avoidance trajectory as a function at one and the same time of an item of information regarding current position of the aircraft provided by the position source, of terrain relief information arising from the database and of terrain relief information provided by the terrain sensor, when the terrain avoidance device receives a warning signal from the terrain warning device; and
a step of providing the valid terrain avoidance trajectory to a guidance system of the aircraft.

In a first embodiment, the step of determining a valid avoidance trajectory comprises the following sub-steps:
determining at least one potential terrain avoidance trajectory as a function of the item of information regarding current position of the aircraft provided by the position source and of the terrain relief information arising from the database;
acquiring from the terrain sensor measured-terrain relief information relating at least to a geographical zone corresponding to the potential terrain avoidance trajectory;
verifying whether the potential terrain avoidance trajectory is at every point above the relief of the measured terrain; and
determining that the potential terrain avoidance trajectory is valid if the potential terrain avoidance trajectory is at every point above the relief of the measured terrain.

In a second embodiment, the step of determining a valid avoidance trajectory comprises the following sub-steps:
acquiring from the terrain sensor measured-terrain relief information relating to a so-called terrain avoidance geographical zone;
acquiring from the database terrain relief information relating to the terrain avoidance geographical zone;
acquiring from the position source an item of information regarding current position of the aircraft;
determining consolidated terrain relief information relating to the terrain avoidance geographical zone as a function of the measured-terrain relief information and terrain relief information arising from the database;
determining the valid terrain avoidance trajectory as a function of the item of information regarding current position of the aircraft and of the consolidated terrain relief information.

The invention also relates to an aircraft comprising a terrain avoidance device such as aforementioned.

### BRIEF DESCRIPTION OF THE DRAWINGS

The invention will be better understood on reading the description which follows and on examining the appended figures.

FIG. 1 illustrates in a simplified manner an aircraft comprising a cockpit.

FIG. 2 represents, in a schematic manner, a terrain avoidance system for an aircraft, in accordance with an embodiment of the invention.

FIGS. 3, 4 and 6 illustrate several examples of measurement of terrain relief information by a terrain sensor.

FIGS. 5a and 5b illustrate an example of consolidation of terrain information.

### DETAILED DESCRIPTION OF THE PREFERRED EMBODIMENTS

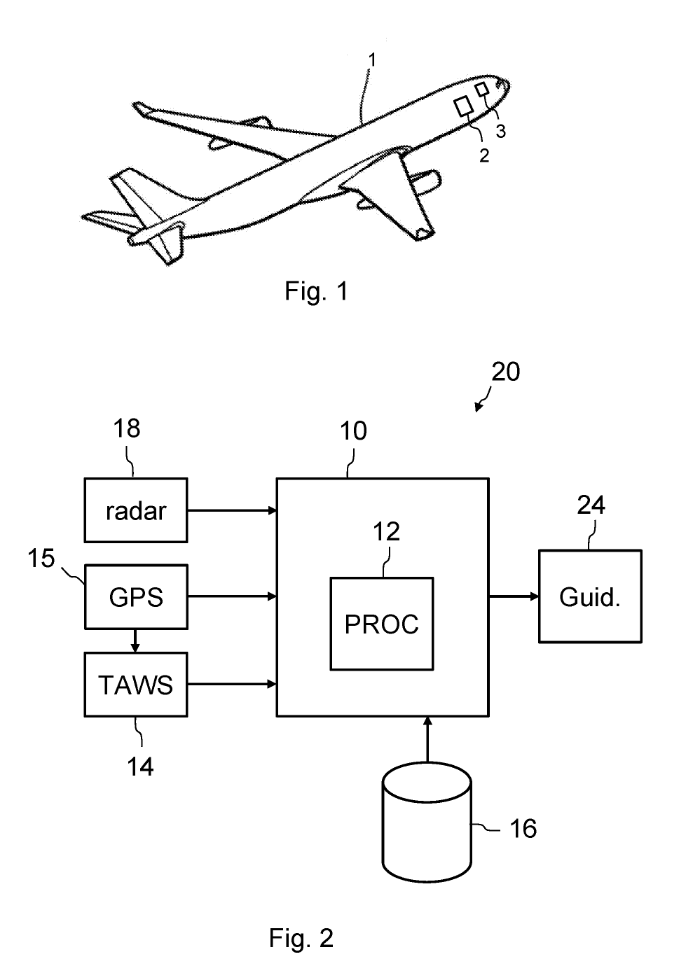

The aircraft 1 represented in FIG. 1 comprises a cockpit 3. The aircraft 1 comprises a terrain avoidance system 20 such as represented in FIG. 2. The terrain avoidance system comprises a terrain avoidance device 10, a terrain warning device 14, a position source 15, a terrain sensor 18, a terrain database 16 and a guidance system 24 of the aircraft. The terrain avoidance device 10, the terrain warning device 14, the database 16 and the guidance system 24 are, for example, located in an avionics bay 2 of the aircraft. The terrain avoidance device 10 comprises at least one processing unit 12 (labelled PROC) in FIG. 2, for example corresponding to a microprocessor or to a microcontroller. The terrain avoidance device 10 is linked at input to the terrain warning device 14, to the terrain sensor 18, to the position source 15 and to the terrain database 16. It is linked at output to the guidance system 24 of the aircraft. The terrain warning device 14 is, for example, a TAWS device of GCAS type or of EGPWS type. In an advantageous manner, the terrain database forms part of the terrain warning device 14. In one embodiment, the position source 15 corresponds to a GPS receiver, for example integrated into a Multi-Mode Receiver MMR. In other embodiments, the position source 15 corresponds to an inertial platform of the aircraft or else to a GPS-inertial hybrid receiver. In a particular embodiment, the guidance system 24 corresponds to at least one guidance computer of the aircraft of FG (“Flight Guidance”) type.

In an advantageous embodiment, the terrain sensor 18 is a radar installed on board the aircraft. This radar is, for example, a meteorological radar placed under a radome at the front of the aircraft. In such a case, this radar is instructed, according to need, to acquire meteorological information or to acquire information regarding the terrain relief in front of the aircraft.

During operation, when the terrain warning device 14 detects a risk of collision of the aircraft with a relief of the terrain, it transmits a warning signal to the terrain avoidance device 10. The processing unit 12 of the terrain avoidance device 10 then acquires an item of information regarding current position of the aircraft from the position source 15, terrain relief information arising from the database 16 and terrain relief information provided by the terrain sensor 18. The processing unit 12 determines a valid terrain avoidance trajectory as a function at one and the same time of the item of information regarding current position of the aircraft, of the terrain relief information arising from the database and of the terrain relief information provided by the terrain sensor. The terrain avoidance device 10 transmits the valid terrain avoidance trajectory to the guidance system 24 which thereafter controls the guidance of the aircraft according to the valid terrain avoidance trajectory thus determined.

In a first embodiment, the processing unit 12 determines at least one potential terrain avoidance trajectory as a function of the item of information regarding current position of the aircraft provided by the position source and of terrain relief information arising from the database. The processing unit 12 determines, for example, the potential avoidance trajectory according to the scheme described in document U.S. Pat. No. 7,899,620B2. Moreover, the processing unit 12 acquires from the terrain sensor measured-terrain relief information relating at least to a geographical zone corresponding to the potential terrain avoidance trajectory. The processing unit verifies whether the potential terrain avoidance trajectory is at every point above the relief of the measured terrain and it determines that the potential terrain avoidance trajectory is valid if the potential terrain avoidance trajectory is at every point above the relief of the measured terrain. In an advantageous manner, the potential avoidance trajectory is determined by taking account of a safety margin with respect to the terrain relief information arising from the database 16. This safety margin is chosen to be greater than the resolution and than the precision of the terrain sensor 18 so as to prevent the potential avoidance trajectory from not being considered valid when the processing unit verifies that it is at every point above the relief of the terrain measured by the sensor 18.

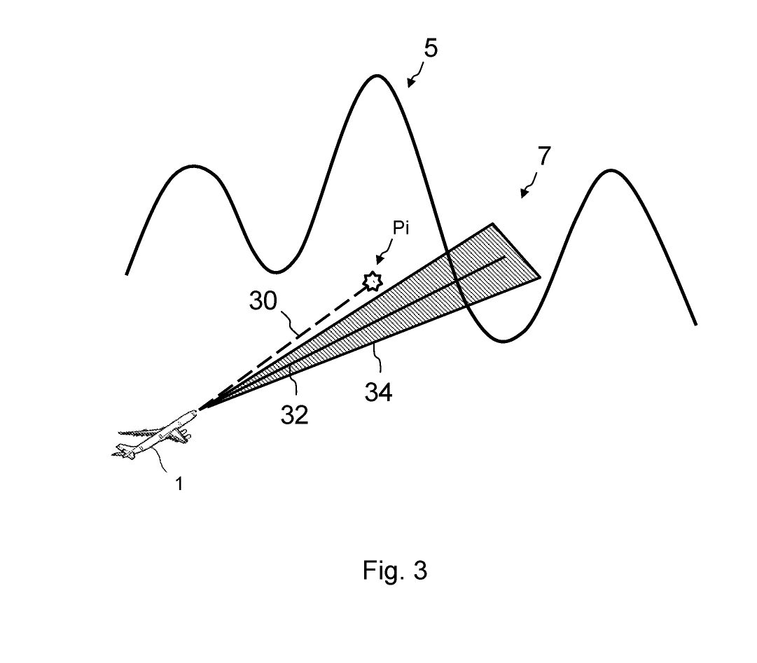

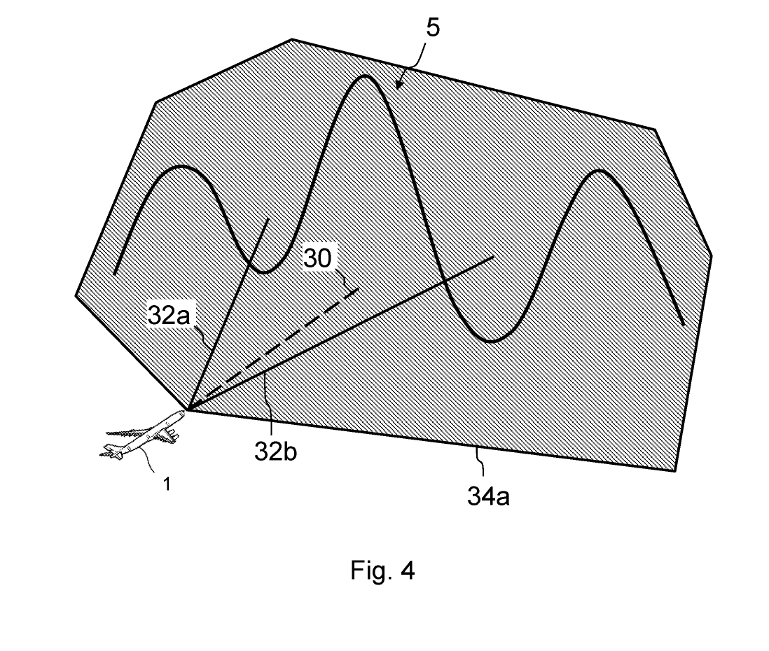

According to a first alternative, the processing unit 12 is configured to instruct the acquisition, by the terrain sensor 18, of the measured-terrain relief information, after the determination of the potential avoidance trajectory. The measured-terrain relief information then relates to a geographical zone corresponding solely to this potential avoidance trajectory. This first alternative is illustrated by FIG. 3. The aircraft 1 follows a current trajectory 30 and the terrain warning device 14 detects a risk of collision of the aircraft with a relief 5 of the terrain, at an impact point Pi, if the aircraft does not modify its current trajectory. The terrain warning device 14 then transmits a warning signal to the terrain avoidance device 10 whose processing unit 12 receives this warning signal. The processing unit 12 then acquires an item of information regarding current position of the aircraft provided by the position source 15 as well as terrain relief information arising from the database 16 and it determines a potential avoidance trajectory 32 as a function of the information. The processing unit 12 then instructs the acquisition, by the terrain sensor 18, of measured-terrain relief information, in a geographical zone 34 corresponding to the potential avoidance trajectory 32. When the terrain sensor 18 is a radar, the geographical zone 34 is, for example, defined in a plane inclined according to a slope corresponding to the optimal climb slope of the aircraft, the geographical zone being delimited laterally in this plane by a predetermined angular amplitude on either side of the potential avoidance trajectory 32. This predetermined angular amplitude is, for example, chosen as a function of the precision with which the aircraft can be guided along the avoidance trajectory and/or as a function of the precision of the terrain sensor 18. The processing unit 12 verifies whether the avoidance trajectory 32 is at every point situated above the relief corresponding to the measured relief information provided by the terrain sensor 18. If such is the case, the processing unit 12 validates the potential avoidance trajectory 32 and then it transmits the valid terrain avoidance trajectory to the guidance system 24 which thereafter controls the guidance of the aircraft following this avoidance trajectory 32. If such is not the case, the processing unit 12 determines a new potential avoidance trajectory as a function of the item of information regarding current position of the aircraft provided by the position source 15 and of the terrain relief information arising from the database 16, and then it repeats the previously described steps.

According to a second alternative illustrated by FIG. 4, the processing unit 12 is configured to instruct the acquisition, by the terrain sensor 18, of the measured-terrain relief information, before the determination of a potential avoidance trajectory. The measured-terrain relief information corresponds to a geographical zone 34a of terrain avoidance. This geographical zone 34a of terrain avoidance is, in particular, a global geographical zone in which the processing unit 12 seeks to determine a potential avoidance trajectory. This geographical zone is preferably determined as a function of the item of information regarding current position of the aircraft. This second alternative is, in particular, advantageous when the terrain sensor 18 is relatively slow to provide the measured-terrain relief information: the terrain sensor 18 can thus acquire this information while the processing unit 12 determines a first potential avoidance trajectory 32a. If this first potential avoidance trajectory is not validated, the information regarding measured terrain relief is then already available to verify one (or several) other potential avoidance trajectory 32b. According to a first variant of the second alternative, the processing unit 12 instructs the acquisition of the measured-terrain relief information, by the terrain sensor 18, subsequent to the reception of the warning signal. This information is then acquired by the terrain sensor only subsequent to a warning signal. In a second variant, the acquisition of the measured-terrain relief information, by the terrain sensor 18, is carried out even before the reception of a warning signal: this acquisition is, for example, carried out periodically during the flight of the aircraft. This makes it possible to anticipate the acquisition of the measured-terrain relief information and so results in better reactivity when determining a valid avoidance trajectory upon the reception of a warning signal by the processing unit 12.

In a particular manner, the processing unit 12 is configured to instruct the acquisition, by the terrain sensor 18, of the measured-terrain relief information corresponding to an optimal climb slope of the aircraft. This is, in particular, advantageous when the terrain sensor 18 is a radar. As illustrated in FIG. 6, the geographical zone in which the radar is instructed to acquire measured-terrain relief information is illustrated by a spatial surface 34b corresponding to a set of potential avoidance trajectories with optimal climb slope (for various changes of heading with respect to the heading of the current trajectory 30 of the aircraft). In so far as the processing unit seeks to determine an avoidance trajectory with optimal climb slope, the knowledge of the information regarding terrain relief measured in this geographical zone 34b is sufficient. It is not necessary to acquire relief information below this geographical zone since the processing unit 12 does not then seek to determine an avoidance trajectory below the geographical zone 34b. Neither is it necessary to acquire relief information above this geographical zone since the aircraft could not fly an avoidance trajectory defined above the geographical zone 34b. Limiting the acquisition of the measured-terrain relief information to this geographical zone 34b allows a substantial time saving in respect of the acquisition of the information regarding terrain relief measured by the radar 18.

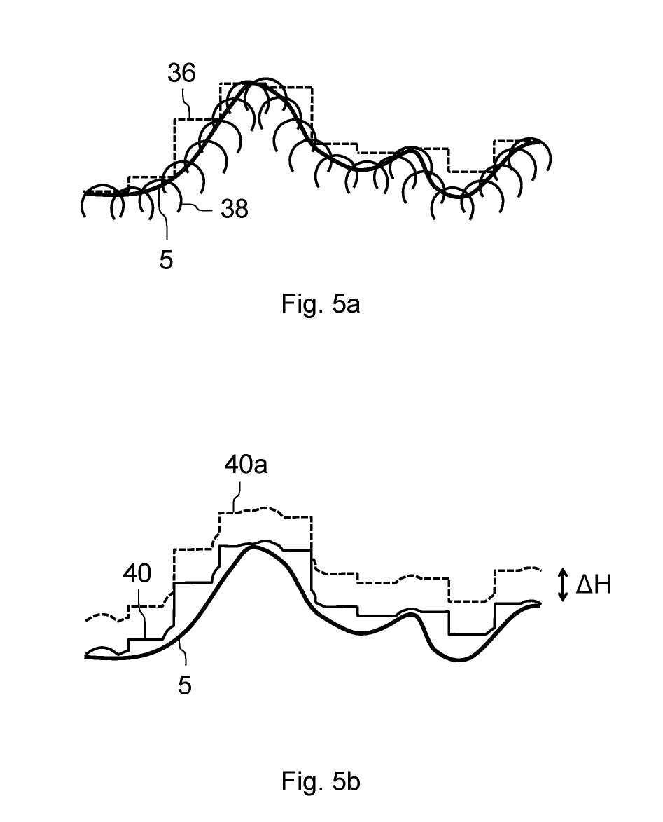

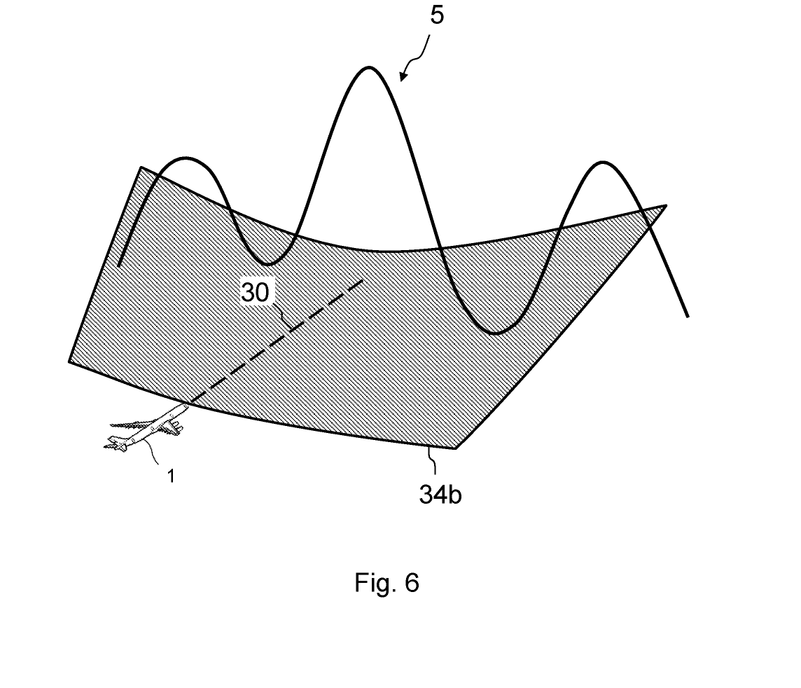

In a second embodiment illustrated by FIGS. 5a and 5b, the processing unit 12 acquires from the terrain sensor 18 measured-terrain relief information 38 relating to a so-called terrain avoidance geographical zone. It also acquires, from the database 16, terrain relief information 36 relating to the terrain avoidance geographical zone. The terrain avoidance geographical zone is a geographical zone in which the processing unit seeks to determine an avoidance trajectory. It is, for example, a geographical zone situated in front of the aircraft 1. This geographical zone is, for example, similar to the geographical zone 34a represented in FIG. 4 and described previously. The processing unit 12 determines consolidated terrain relief information 40 as a function of the measured-terrain relief information 38 arising from the terrain sensor 18 and terrain relief information 36 arising from the database 16. Accordingly, in a particular exemplary embodiment, the terrain avoidance geographical zone being subdivided into a set of elementary geographical zones, the processing unit 12 determines, in each elementary geographical zone, a consolidated item of information regarding relief of the terrain corresponding to the higher item of information regarding terrain relief out of the item of information regarding terrain relief arising from the database and the item of information regarding relief of the measured terrain corresponding to this elementary geographical zone. The processing unit 12 thereafter determines the valid terrain avoidance trajectory as a function of the consolidated terrain relief information, for example by using the scheme described in document U.S. Pat. No. 7,899,620B2 which is incorporated herein by reference. According to a first alternative, the acquisition of the information regarding relief of the terrain measured by the terrain sensor 18 is instructed by the processing unit 12 subsequent to the reception of a warning signal arising from the terrain warning device 14. According to a second alternative, the terrain sensor 18 is instructed to carry out the acquisition of measured-terrain relief information independently of the occurrence of such a warning signal. This acquisition is, for example, carried out periodically during the flight of the aircraft. Thus, the measured-terrain relief information is already available upon the occurrence of a warning signal arising from the terrain warning device 14. In an advantageous manner, the consolidated terrain relief information 40 is increased by a height margin ΔH as represented by the curve 40a in FIG. 5b. This makes it possible to provide a safety margin between the terrain and the avoidance trajectory determined.

In the various aforementioned embodiments, after having determined the valid terrain avoidance trajectory the terrain avoidance device 10 transmits this valid terrain avoidance trajectory to the guidance system 24 of the aircraft which receives it and which thereafter controls the guidance of the aircraft according to the valid terrain avoidance trajectory. In a first alternative, the guidance system 24 automatically selects the valid avoidance trajectory, in replacement for the current trajectory 30 of the aircraft, after the reception of the valid avoidance trajectory, and then it controls the guidance of the aircraft along the trajectory. In a second alternative, the guidance system 24 presents information relating to the valid avoidance trajectory on a screen of the cockpit of the aircraft, and then it waits for possible confirmation of the valid avoidance trajectory by an operator, in particular a pilot of the aircraft. If an operator confirms the valid avoidance trajectory, the guidance system 24 selects this valid avoidance trajectory in replacement for the current trajectory 30 of the aircraft and it controls the guidance of the aircraft along the valid avoidance trajectory.

According to a first variant, the terrain avoidance device 10 is distinct from the terrain warning system 14 and from the guidance system 24 of the aircraft. It corresponds, for example, to a computer of LRU (“Line Replaceable Unit”) type or to a function implemented by a modular avionics computer IMA (“Integrated Modular Avionics”). According to a second variant, the terrain avoidance device 10 is integrated into the terrain warning system 14. The database 16 is then advantageously integrated, likewise, into the terrain warning system 14. According to a third variant, the terrain avoidance device 10 is integrated into the guidance system 24.

According to a first alternative, the valid terrain avoidance trajectory corresponds to a trajectory defined on the basis of the current position of the aircraft. According to a second alternative, the valid terrain avoidance trajectory corresponds to a heading setting or course setting for the aircraft, associated with a climb slope setting for the aircraft. In a first example, this climb slope setting corresponds to a predetermined climb slope. In a second example, this climb slope setting corresponds to a maximum climb slope flyable by the aircraft.

While at least one exemplary embodiment of the present invention(s) is disclosed herein, it should be understood that modifications, substitutions and alternatives may be apparent to one of ordinary skill in the art and can be made without departing from the scope of this disclosure. This disclosure is intended to cover any adaptations or variations of the exemplary embodiment(s). In addition, in this disclosure, the terms “comprise” or “comprising” do not exclude other elements or steps, the terms “a” or “one” do not exclude a plural number, and the term “or” means either or both. Furthermore, characteristics or steps which have been described may also be used in combination with other characteristics or steps and in any order unless the disclosure or context suggests otherwise. This disclosure hereby incorporates by reference the complete disclosure of any patent or application from which it claims benefit or priority.

1. A terrain avoidance device for an aircraft, the terrain avoidance device comprising a processing unit and being configured to be linked:
to a terrain warning device of the aircraft, which monitors the flight of the aircraft with respect to the surrounding terrain and which is liable to emit a warning signal when the aircraft risks a collision with a relief of the terrain if it maintains its current flight characteristics;
to a position source of the aircraft, liable to provide an item of information regarding current position of the aircraft; and
to a terrain relief database,
to a terrain sensor of the aircraft, liable to provide terrain relief information,
in which the processing unit of the terrain avoidance device is configured to:
determine a valid terrain avoidance trajectory as a function at one and the same time of an item of information regarding current position of the aircraft provided by the position source, of terrain relief information arising from the database and of terrain relief information provided by the terrain sensor, when the terrain avoidance device receives a warning signal from the terrain warning device;
provide the valid terrain avoidance trajectory to a guidance system of the aircraft,
determine at least one potential terrain avoidance trajectory as a function of the item of information regarding current position of the aircraft provided by the position source and of terrain relief information arising from the database;
acquire from the terrain sensor measured-terrain relief information relating at least to a geographical zone corresponding to the potential terrain avoidance trajectory;
verify whether the potential terrain avoidance trajectory is at every point above the relief of the measured terrain; and
determine that the potential terrain avoidance trajectory is valid if the potential terrain avoidance trajectory is at every point above the relief of the measured terrain.

2. The device according to claim 1, wherein the processing unit is configured to instruct the acquisition, by the terrain sensor, of the measured-terrain relief information, after the determination of the potential avoidance trajectory, the measured-terrain relief information being related to a geographical zone corresponding to this potential avoidance trajectory.

3. The device according to claim 1, wherein the processing unit is configured to instruct the acquisition, by the terrain sensor, of the measured-terrain relief information, before the determination of a potential avoidance trajectory, the measured-terrain relief information corresponding to a geographical zone of terrain avoidance.

4. The device according to claim 3, wherein the processing unit is configured to instruct the acquisition, by the terrain sensor, of the measured-terrain relief information corresponding to an optimal climb slope of the aircraft.

5. The device according to claim 1, wherein the terrain sensor is a radar installed on board the aircraft.

6. The device according to claim 5, wherein the radar is a radar liable to be instructed to acquire meteorological information or terrain relief information.

7. A terrain avoidance method for an aircraft, the aircraft comprising:
a terrain warning device which monitors the flight of the aircraft with respect to the surrounding terrain and which is liable to emit a warning signal when the aircraft risks a collision with a relief of the terrain if it maintains its current flight characteristics;
a position source, liable to provide an item of information regarding current position of the aircraft;
a terrain sensor liable to provide terrain relief information; and
a terrain avoidance device linked to the terrain warning device, to the position source, to a terrain relief database as well as to the terrain sensor, the terrain avoidance device comprising a processing unit,
the method comprising:
determining, by the processing unit, a valid terrain avoidance trajectory as a function at one and the same time of an item of information regarding current position of the aircraft provided by the position source, of terrain relief information arising from the database and of terrain relief information provided by the terrain sensor, when the terrain avoidance device receives a warning signal from the terrain warning device; and
a step of providing the valid terrain avoidance trajectory to a guidance system of the aircraft,
wherein the step of determining a valid avoidance trajectory comprises the following sub-steps:
determining at least one potential terrain avoidance trajectory as a function of the item of information regarding current position of the aircraft provided by the position source and of the terrain relief information arising from the database;
acquiring from the terrain sensor measured-terrain relief information relating at least to a geographical zone corresponding to the potential terrain avoidance trajectory;
verifying whether the potential terrain avoidance trajectory is at every point above the relief of the measured terrain; and
determining that the potential terrain avoidance trajectory is valid if the potential terrain avoidance trajectory is at every point above the relief of the measured terrain.

8. An aircraft comprising a terrain avoidance device according to claim 1.
